(19) United States
(12) Patent Application Publication
(10) Pub. No.: US 2020/0023708 A1
(43) Pub. Date: Jan. 23, 2020

(54) A CONDITIONED AIR DISTRIBUTION SYSTEM FOR A VEHICLE

(71) Applicant: Ford Global Technologies, LLC, Dearborn, MI (US)

(72) Inventors: Gary D. Mullen, Plymouth, MI (US); Nicholas Andrew Mazzocchi, Ann Arbor, MI (US); Mitali Chakrabarti, Canton, MI (US); John A. Shinska, Macomb, MI (US)

(73) Assignee: Ford Global Technologies, LLC, Dearborn, MI (US)

(21) Appl. No.: 16/039,411

(22) Filed: Jul. 19, 2018

(51) Int. Cl. B60H 1/00; B60H 1/24

(52) U.S. Cl. CPC B60H 1/00564; B60H 1/241; B60H 1/00464

(57) ABSTRACT

A vehicle is provided herein. The vehicle includes a windshield positioned between an instrument panel and a headliner. A duct is positioned above the headliner and has an inlet and an outlet. An air conditioning system is configured to push conditioned air out of the instrument panel generally toward the inlet. A fan is proximate the inlet and is configured to draw the conditioned air into the inlet and push the conditioned air out of the outlet toward a vehicle window proximate the outlet.

### FIELD OF THE INVENTION

The present invention generally relates to a conditioned air distribution system for a vehicle, and more particularly, to a conditioned air distribution system in a vehicle for demisting rear side windows.

### BACKGROUND OF THE INVENTION

Vehicle air conditioning systems often include connected duct systems to distribute conditioned air to different portions of the vehicle. These duct systems are bulky and often continuously extend through the floor, doors, and/or pillars of the vehicle.

### SUMMARY OF THE INVENTION

According to one aspect of the present invention, a vehicle includes an air conditioning system that is configured to push conditioned air out of an instrument panel across a windshield toward a headliner positioned above the windshield. A fan that is proximate to the headliner and the windshield is configured to draw the conditioned air into a duct positioned above the headliner.

Embodiments of the first aspect of the invention can include any one or a combination of the following features:
the conditioned air is unconstrained within a cabin of the vehicle after being pushed out of the instrument panel and before being drawn into the duct;
the fan is configured to draw the conditioned air into an inlet of the duct and push the conditioned air out of an outlet of the duct;
a vehicle window is positioned proximate the outlet of the duct, wherein the fan is configured to push the conditioned air out of the outlet of the duct toward the vehicle window;
the vehicle window is a side window of the vehicle;
the side window is disposed on a door of the vehicle;
the door is configured to open by sliding;
the side window is operable between an open position and a closed position relative to the door; and
the fan is a turbine fan.

According to another aspect of the present invention, a vehicle includes a windshield disposed between an instrument panel and a headliner. An air conditioning system is configured to push conditioned air out of the instrument panel into a cabin of the vehicle. A duct is disposed above the headliner. A fan is coupled to the duct and is configured to draw the conditioned air from the cabin into the duct and push the conditioned air out of the duct and into the cabin.

Embodiments of the second aspect of the invention can include any one or a combination of the following features:
the vehicle further comprises a vehicle window positioned vehicle rearward of the windshield, wherein the fan is configured to push air out of the duct and into the cabin toward the vehicle window;
the conditioned air is dehumidified by the air conditioning system before being pushed out of the instrument panel;
the air conditioning system is further configured to push the conditioned air out of the instrument panel and across the windshield toward the headliner; and
the air conditioning system is positioned vehicle-lower than the windshield.

According to yet another aspect of the present invention, a vehicle includes a windshield positioned between an instrument panel and a headliner. A duct is positioned above the headliner and has an inlet and an outlet. An air conditioning system is configured to push conditioned air out of the instrument panel generally toward the inlet. A fan is proximate the inlet and is configured to draw the conditioned air into the inlet and push the conditioned air out of the outlet toward a vehicle window proximate the outlet.

Embodiments of the third aspect of the invention can include any one or a combination of the following features:
the air conditioning system is configured to push the conditioned air out of the instrument panel such that the conditioned air flows along a curvature of the windshield toward the inlet;
the vehicle further comprises a flow influencing feature coupled to the outlet and configured to direct the conditioned air being pushed out of the outlet toward the vehicle window;
the vehicle window is a side window of the vehicle;
the air conditioning system is configured to push the conditioned air out of a vent feature in the instrument panel, wherein the vent feature is configured to direct the conditioned air toward the inlet; and
the conditioned air is unconstrained within a cabin of the vehicle after being pushed out of the instrument panel and before being drawn into the duct.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a partial cross-sectional view of a vehicle, illustrating the flow of conditioned air from an air conditioning system into a vehicle interior, then into a duct above a headliner and then back into a vehicle interior proximate a vehicle window, according to one embodiment;

FIG. 2A is a perspective view of the vehicle, illustrating the air conditioning system, a fan, and the duct positioned above the headliner in phantom, according to one embodiment;

FIG. 2B is a perspective view of the vehicle, illustrating a sliding door in an open position, according to one embodiment;

FIG. 3 is a top down view of the vehicle, illustrating the duct in phantom, according to one embodiment; and

FIG. 4 is a top down view of the vehicle, illustrating the duct in phantom, according to one embodiment.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

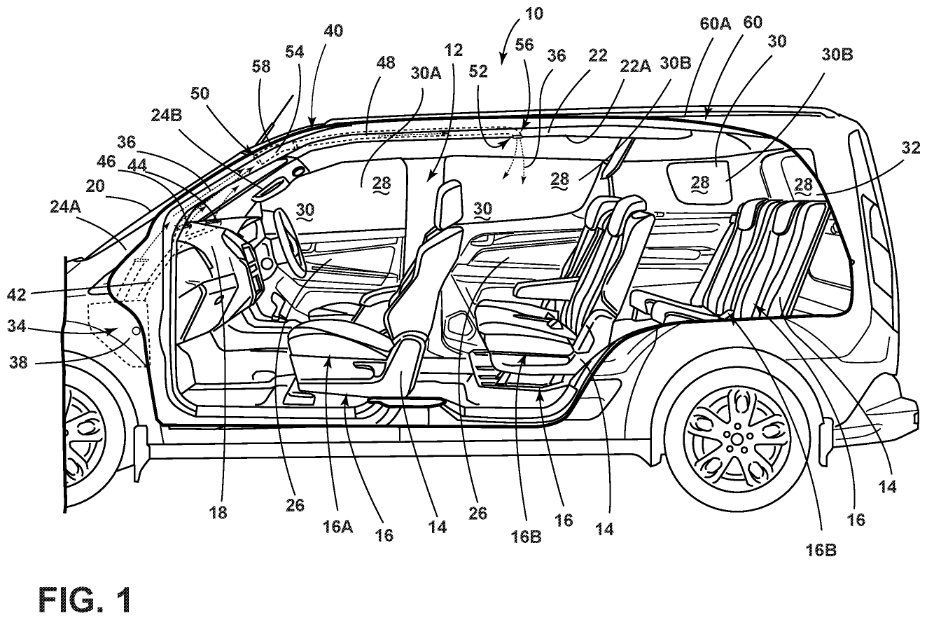

In reference to FIGS. 1-4, a vehicle 10 includes a vehicle interior 12. The vehicle interior 12 includes a windshield 20 positioned between an instrument panel 18 and a headliner 22. A duct 48 is positioned above the headliner 22 and includes an inlet 50 and an outlet 52. An air conditioning system 34 is configured to push conditioned air 36 out of the instrument panel 18 and generally toward the inlet 50. A fan 54 is proximate the inlet 50 and is configured to draw the conditioned air 36 into the inlet 50 and push the conditioned air 36 out of the outlet 52 toward a vehicle window 28 positioned proximate the outlet 52.

Referring now to FIG. 1, the vehicle 10 is shown. In various embodiments, the vehicle 10 may be any one of a variety of vehicle types (e.g., truck, sedan, SUV, bus, etc.). In one exemplary embodiment, the vehicle 10 may be a van. The vehicle 10 includes the vehicle interior 12. The vehicle interior 12 generally defines a cabin 40. The vehicle interior 12 may include one or more seats 14. In various embodiments, the one or more seats 14 may be a variety of seat types (e.g., captain's chairs, bench seats, bucket seats, etc.). The one or more seats 14 may be arranged in rows 16 within the vehicle interior 12. For example, in some embodiments, the one or more seats 14 may be arranged in a front row 16A and a rear row 16B positioned vehicle rearward of the front row 16A. It is contemplated that, in some embodiments, there may be a plurality of rear rows 16B positioned vehicle rearward of the front row 16A. For example, as shown in FIG. 1, the vehicle interior 12 may include a front row 16A, a first rear row 16B positioned vehicle rearward of the front row 16A and a second rear row 16B positioned vehicle rearward of the first rear row 16B. It is further contemplated that, in some embodiments, the one or more seats 14 in the vehicle interior 12 may be movable or positioned such that the one or more seats 14 are not arranged in rows 16.

In further reference to FIG. 1, the vehicle interior 12 may include the instrument panel 18. As shown in FIG. 1, in various embodiments, the instrument panel 18 may be conventionally positioned near the vehicle forward end of the vehicle interior 12. However, it is contemplated that, in some embodiments, the instrument panel 18 may be positioned in various positions throughout the vehicle interior 12.

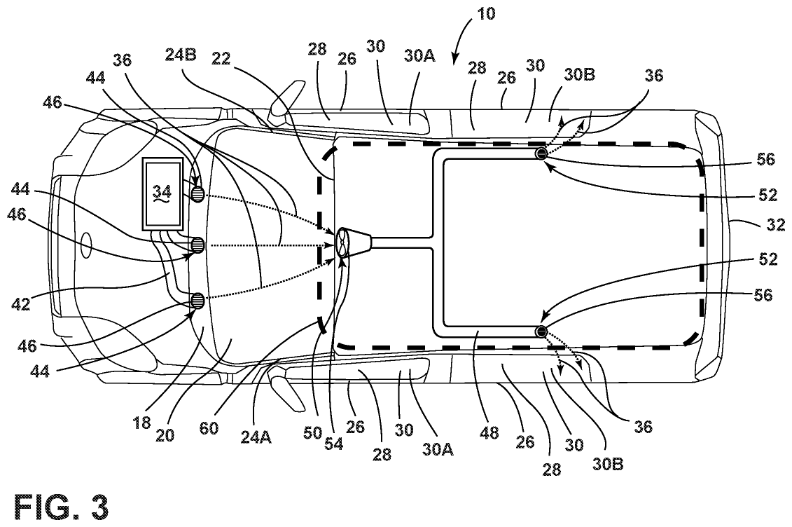

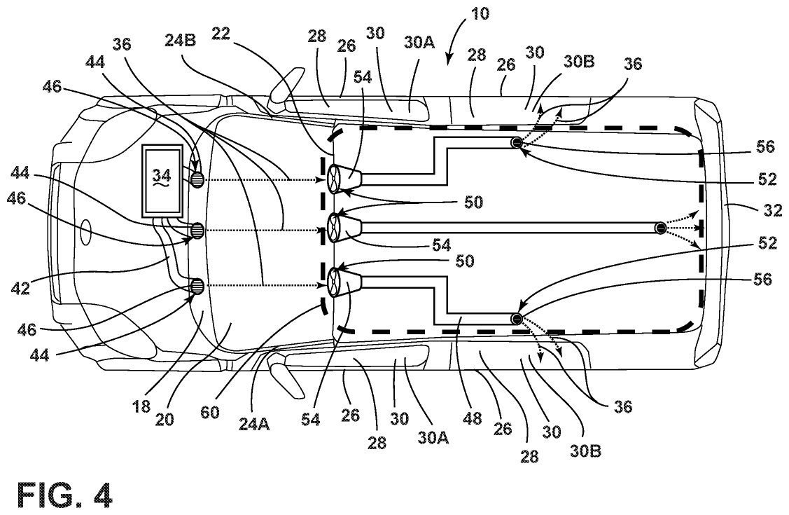

The vehicle interior 12 may include the windshield 20. As shown in FIG. 1, the windshield 20 may extend generally upward from the instrument panel 18. In some embodiments, the windshield 20 may be shaped such that it has a curvature. The curvature of the windshield 20 may generally bow outward from the vehicle interior 12. In various embodiments, a first A-pillar 24A and a second A-pillar 24B may laterally bound the windshield 20, as shown in FIGS. 3 and 4. In some embodiments, the first A-pillar 24A and the second A-pillar 24B may extend generally upward from the instrument panel 18.

In various embodiments, the vehicle interior 12 may include the headliner 22. In some embodiments, the headliner 22 may be positioned above the windshield 20. The headliner 22 may extend vehicle rearward from the windshield 20. In some embodiments, the headliner 22 may extend vehicle rearward from the first A-pillar 24A and/or the second A-pillar 24B. The headliner 22 may include an inner surface 22A. The inner surface 22A may face vehicle downward. In various embodiments, the windshield 20 may be positioned between the instrument panel 18 and the headliner 22, as shown in FIG. 1.

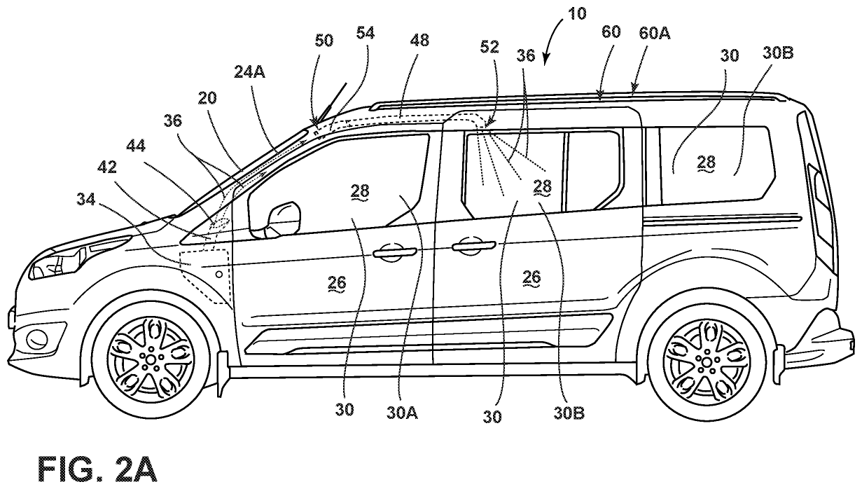

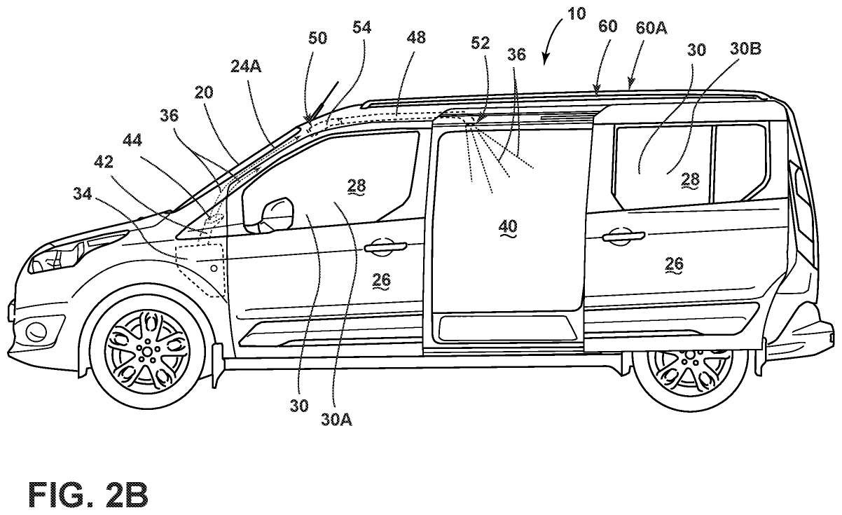

Referring now to FIGS. 1-2B, the vehicle 10 may include a roof 60. The roof 60 may be vehicle upward of the headliner 22 and define an outer surface 60A of the vehicle 10. The outer surface 60A may generally face vehicle upward. The vehicle 10 may further include one or more doors 26. In some embodiments, the one or more doors 26 may include a sliding door, as depicted in FIGS. 2A and 2B. In other words, one or more doors 26 may be configured to open and close by sliding. It is contemplated that, in various embodiments, the one or more doors 26 may open and close in a variety of ways known to a person having ordinary skill in the art (e.g., swinging, pivoting, etc.).

In various embodiments, the vehicle 10 may include one or more vehicle windows 28 located vehicle rearward of the windshield 20. In some embodiments, the vehicle windows 28 may be operable between open and closed positions. It is contemplated that, in various embodiments, the vehicle windows 28 may move between the open and closed positions in at least one of a host ways that would be known to one skilled in the art (e.g., sliding, pivoting, etc.).

In various embodiments, the vehicle 10 may include a variety of types of vehicle windows 28. For example, the vehicle 10 may include one or more side windows 30 and/or a back window 32, as shown in FIG. 1. In some embodiments, the side windows 30 may correspond to the rows 16 within the vehicle interior 12. For example, as depicted in FIG. 1, a front side window 30A generally corresponds with the front row 16A, while a plurality of rear side windows 30B generally correspond with rear rows 16B. It is contemplated that, in some embodiments, the side windows 30 need not correspond to rows 16, and that side windows 30 positioned vehicle rearward of other side windows 30 may be rear side windows 30B, irrespective of the arrangement of the seats 14 in the vehicle interior 12.

In various embodiments, the one or more side windows 30 may be positioned on the one or more doors 26. For example, as shown in FIGS. 2A and 2B, the side window 30 may be disposed on the sliding door 26. In some embodiments, the one or more side windows 30 may be configured to open and close relative to the one or more doors 26. In other words, the side window 30 may be configured to move between the open position and the closed position relative to the door 26.

Referring now to FIGS. 1-2B, the vehicle 10 may include the air conditioning system 34 configured to push conditioned air 36 into the cabin 40 of the vehicle 10. The air conditioning system 34 may include a heating, ventilation, and air conditioning (HVAC) unit 38 that may include components, such as the common components of the refrigeration cycle, a filter, and an HVAC fan. However, it is contemplated that, in various embodiments, the air conditioning system 34 may be any suitable system configured to move, ventilate, heat, cool, dehumidify, clean, and/or filter air. As such, it is to be understood that conditioned air 36 refers to air that has been modified by the air conditioning system 34 by at least one of movement, ventilation, heating, cooling, dehumidifying, cleaning, filtering, and/or a combination thereof

In various embodiments, the air conditioning system 34 may include a duct assembly 42 that may be configured to direct the flow of conditioned air 36 through the instrument panel 18. In some embodiments, a vent feature 44 may be coupled to the instrument panel 18 and configured to direct the flow of the conditioned air 36 as it exits the instrument panel 18. In some embodiments, the vent feature 44 may include one or more vanes 46 to direct the flow of the conditioned air 36 in a desired direction. It is contemplated that the vent feature 44 may include any suitable feature for directing the flow of the conditioned air 36 out of the instrument panel 18 (e.g., grate, nozzle, slits, apertures, registers, etc.). In some embodiments, the vent feature 44 may be configured to direct the conditioned air 36 toward and/or across the windshield 20, such that the conditioned air 36 may defrost or defog the windshield 20. In some embodiments, the vent feature 44 may be configured to direct the conditioned air 36 toward the headliner 22. In various embodiments, the conditioned air 36 is dehumidified by the air conditioning system 34 before being pushed out of the instrument panel 18. It is contemplated that, in some embodiments, the air conditioning system 34 and/or the HVAC unit 38 may be positioned vehicle-lower than the windshield 20. It is further contemplated that, in some embodiments, the air conditioning system 34 and/or the HVAC unit 38 may be positioned vehicle forward of the instrument panel 18.

Referring now to FIG. 1, the duct 48 may be positioned above the headliner 22. In some embodiments, the duct 48 may be positioned between the headliner 22 and the roof 60. In some embodiments, the duct 48 may be positioned between the inner surface 22A of the headliner 22 and the outer surface 60A of the vehicle 10 defined by the roof 60. In various embodiments, the duct 48 may be coupled to the headliner 22. In some embodiments, the duct 48 may be integral with the headliner 22 and/or defined by the headliner 22.

As shown in FIG. 1, the duct 48 may include the inlet 50 and the outlet 52. In various embodiments, the inlet 50 and/or the outlet 52 may be coupled to the headliner 22. In some embodiments, the inlet 50 and/or the outlet 52 may extend through the headliner 22, such that the inlet 50 and/or the outlet 52 are in open communication with the cabin 40. The inlet 50 may be positioned vehicle forward of the outlet 52. As depicted in FIG. 1, in various embodiments, the inlet 50 may be proximate the windshield 20. In some embodiments, the inlet 50 may be positioned between the first A-pillar 24A and the second A-pillar 24B. In other words, the inlet 50 may be entirely laterally inboard of the periphery of the first A-pillar 24A and the second A-pillar 24B. In various embodiments, the outlet 52 is positioned proximate the vehicle window 28. In some embodiments, the outlet 52 is positioned proximate the side window 30. In some embodiments, the outlet 52 is positioned proximate the rear side window 30B. It is contemplated that the outlet 52 may be positioned proximate the back window 32.

Referring now to FIGS. 3 and 4, in various embodiments, the inlet 50 and/or the outlet 52 may respectively include a plurality of inlets 50 and/or outlets 52. For example, in some embodiments, the duct 48 may include one inlet 50 and multiple outlets 52, as shown in FIG. 3. Further, in some embodiments, the duct 48 may include multiple inlets 50 and multiple outlets 52, as shown in FIG. 4. It is contemplated that, in some embodiments, the duct 48 may include any number of inlets 50 and/or outlets 52, and that the duct 48 may include a plurality of ducts 48, which may each have one or more inlets 50 and/or outlets 52.

Referring now to FIGS. 1, 3, and 4, the fan 54 is depicted. In various embodiments, the fan 54 may be coupled to the headliner 22. In some embodiments the fan 54 may be embedded in the headliner 22. In some embodiments, the fan 54 may be coupled to the duct 48 and/or the inlet 50. In some embodiments, the fan 54 may be positioned within the duct 48 and/or the inlet 50. In various embodiments, the fan 54 may be positioned proximate the windshield 20, the headliner 22, the inlet 50, and/or a combination thereof

As depicted in FIG. 1, the fan 54 may be configured to draw conditioned air 36 from the cabin 40 into the duct 48. In various embodiments, the fan 54 may be configured to draw the conditioned air 36 into the inlet 50 of the duct 48. In various embodiments, the conditioned air 36 is unconstrained within the cabin 40 when it is drawn into the duct 48 by the fan 54. In other words, the conditioned air 36 is disposed within the cabin 40 of the vehicle 10 and has been pushed out of the air conditioning system 34 and is not contained within the duct assembly 42 of the air conditioning system 34, when it is drawn into the duct 48 by the fan 54. In various embodiments, the conditioned air 36 is unconstrained within the cabin 40 of the vehicle 10 after being pushed out of the instrument panel 18 and before being drawn into the duct 48.

As further shown in FIG. 1, the fan 54 is configured to push the conditioned air 36 drawn into the duct 48 by the fan 54 out of the duct 48 and back into the cabin 40. In various embodiments, the fan 54 is configured to push the conditioned air 36 out of the duct 48 through the outlet 52. In some embodiments, the fan 54 may be configured to push the conditioned air 36 out of the outlet 52 toward the vehicle window 28. In some embodiments, the fan 54 may be configured to push the conditioned air 36 toward the side window 30 and/or the rear side window 30B. The conditioned air 36 may be pushed out of the outlet 52 toward the vehicle window 28, in part, due to the outlet 52 being proximate to and/or directed towards the vehicle window 28. It is contemplated that the fan 54 may be any one of a variety of fan types suitable to draw air into the duct 48 and/or push air out of the duct 48. For example, in some embodiments, the fan 54 may be an electric powered turbine fan 58.

In some embodiments, a flow influencing feature 56 may be coupled to and/or proximate the outlet 52 and configured to influence the direction of the flow of the conditioned air 36 being pushed out of the outlet 52. It is contemplated that the flow influencing feature 56 may be any suitable feature configured to influence the direction of the flow of the conditioned air 36 coming out of the outlet 52 (e.g., grille, register, nozzle, etc.) and further, that the flow influencing feature 56 may direct the flow of the conditioned air 36 toward the vehicle window 28. It is further contemplated that, in some embodiments, the flow influencing feature 56 may direct the conditioned air 36 in any vehicular direction and further may be adjustable, such that the direction of the flow of the conditioned air 36 may be changed.

Referring further to FIG. 1, in some embodiments, the air conditioning system 34 is configured to push conditioned air 36 out of the instrument panel 18 toward the fan 54. For example, the air conditioning system 34 may push the conditioned air 36 toward and/or across the windshield 20, such that the conditioned air 36 flows vehicle upward along the windshield 20 and/or along the curvature of the windshield 20 towards the fan 54. In some embodiments, the air conditioning system 34 may push the conditioned air 36 directly towards the headliner 22 and/or toward the inlet 50 in the direction of the fan 54. Pushing the conditioned air 36 toward the fan 54 may better enable the fan 54 to draw the conditioned air 36 into the duct 48 and may minimize the amount of unconditioned ambient air within the cabin 40 being drawn into the duct 48 by the fan 54.

In operation for some embodiments of the vehicle 10, the air conditioning system 34 may push dehumidified conditioned air 36 out of the instrument panel 18 and into the cabin 40 of the vehicle 10, wherein the fan 54 may draw the dehumidified conditioned air 36 into the duct 48 positioned above the headliner 22 through the inlet 50, which is proximate the windshield 20, and then push the conditioned air 36 out of the outlet 52 back into the cabin 40 and toward the rear side window 30B, wherein the dehumidified conditioned air 36 defogs the rear side window 30B.

Further, in operation for some embodiments of the vehicle 10, the air conditioning system 34 may push heated conditioned air 36 out of the instrument panel 18 and into the cabin 40 toward the windshield 20, such that the heated conditioned air 36 moves across the windshield 20 toward the headliner 22, wherein the fan 54 may draw the heated conditioned air 36 into the duct 48 positioned between the inner surface 22A of the headliner 22 and the outer surface 60A of the vehicle 10 defined by the roof 60, and then push the heated conditioned air 36 out of the duct 48 into the cabin 40 and toward the rear side window 30B, wherein the heated conditioned air 36 defrosts the rear side window 30B.

Use of the present disclosure may provide a variety of advantages. First, the concentrated distribution of the conditioned air 36 to the rear side window 30B enables defrosting and defogging of the rear side window 30B. Second, the fan 54 drawing unconstrained conditioned air 36 from the cabin 40 for redistribution circumvents the need to run a series of ducts from the air conditioning system 34 through the floor, doors 26, and/or the first and second A-pillars 24A, 24B (and/or B-pillars) of the vehicle 10 in order to demist the rear side windows 30B and the back window 32. This advantage has a multitude of potential benefits, including reducing vehicle costs, conserving space, and creating an aesthetically streamlined vehicle interior 12 without unduly bulky features (e.g., A-pillars). Further, the fan 54 drawing unconstrained conditioned air 36 from the cabin 40 and pushing the conditioned air 36 out of the duct 48 disposed above the headliner 22 toward the rear side window 30B is especially advantageous when demisting an openable rear side window 30B positioned on the sliding door 26 is a priority, because of the existing difficulties of implementing a conventional duct system capable of effectively demisting an openable rear side window 30B positioned on a sliding door 26.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle, comprising:
an air conditioning system configured to push conditioned air out of an instrument panel and across a windshield toward a headliner positioned above the windshield; and
a fan proximate to the headliner and the windshield, configured to draw the conditioned air into a duct positioned above the headliner.

2. The vehicle of claim 1, wherein the conditioned air is unconstrained within a cabin of the vehicle after being pushed out of the instrument panel and before being drawn into the duct.

3. The vehicle of claim 2, wherein the fan is configured to draw the conditioned air into an inlet of the duct and push the conditioned air out of an outlet of the duct.

4. The vehicle of claim 3, further comprising:
a vehicle window positioned proximate to the outlet of the duct, wherein the fan is configured to push the conditioned air out of the outlet of the duct toward the vehicle window.

5. The vehicle of claim 4, wherein the vehicle window is a side window of the vehicle.

6. The vehicle of claim 5, wherein the side window is disposed on a door of the vehicle.

7. The vehicle of claim 6, wherein the door is configured to open by sliding.

8. The vehicle of claim 7, wherein the side window is operable between an open position and a closed position relative to the door.

9. The conditioned air distribution system of claim 1, wherein the fan is a turbine fan.

10. A vehicle, comprising:
a windshield disposed between an instrument panel and a headliner;
an air conditioning system configured to push conditioned air out of the instrument panel into a cabin of the vehicle;
a duct disposed above the headliner; and
a fan coupled to the duct and configured to draw the conditioned air from the cabin into the duct and push the conditioned air out of the duct and into the cabin.

11. The vehicle of claim 10, further comprising a vehicle window positioned vehicle rearward of the windshield, wherein the fan is configured to push air out of the duct and into the cabin toward the vehicle window.

12. The vehicle of claim 10, wherein the conditioned air is dehumidified by the air conditioning system before being pushed out of the instrument panel.

13. The vehicle of claim 10, wherein the air conditioning system is further configured to push the conditioned air out of the instrument panel and across the windshield toward the headliner.

14. The vehicle of claim 10, wherein the air conditioning system is positioned vehicle-lower than the windshield.

15. A vehicle, comprising:
a windshield positioned between an instrument panel and a headliner;
a duct positioned above the headliner, having an inlet and an outlet;
an air conditioning system configured to push conditioned air out of the instrument panel generally toward the inlet; and
a fan proximate the inlet and configured to draw the conditioned air into the inlet and push the conditioned air out of the outlet toward a vehicle window proximate the outlet.

16. The vehicle of claim 15, wherein the air conditioning system is configured to push the conditioned air out of the instrument panel such that the conditioned air flows along a curvature of the windshield toward the inlet.

17. The vehicle of claim 15, further comprising a flow influencing feature coupled to the outlet and configured to direct the conditioned air being pushed out of the outlet toward the vehicle window.

18. The vehicle of claim 17, wherein the vehicle window is a side window of the vehicle.

19. The vehicle of claim 15, wherein the air conditioning system is configured to push the conditioned air out of a vent feature in the instrument panel, wherein the vent feature is configured to direct the conditioned air toward the inlet.

20. The vehicle of claim 15, wherein the conditioned air is unconstrained within a cabin of the vehicle after being pushed out of the instrument panel and before being drawn into the duct.
